(19) United States
(12) Patent Application Publication
(10) Pub. No.: US 2002/0194604 A1
(43) Pub. Date: Dec. 19, 2002

(54) Interactive television virtual shopping cart

(76) Inventors: Elizabeth C. Sanchez, Ben Lomond, CA (US); Jack Armstrong, Sharon, MA (US); Steven J. Szymanski, Mountain View, CA (US)

Correspondence Address: Rory D. Rankin, Conley, Rose, & Tayon, P.C., P.O. Box 398, Austin, TX, 78767, US

(21) Appl. No.: 09/885,794

(22) Filed: Jun. 19, 2001

(51) Int. Cl. G06F 17/60; G06F 3/00; H04N 5/445; G06F 13/00

(52) U.S. Cl. 725/60; 705/26

(57) ABSTRACT

A method and mechanism for facilitating product purchases in an interactive television system. A programming stream is conveyed from a broadcast station to a receiver. In addition to the programming content, the stream which is broadcast has been tagged with information describing products and services which may be purchased. Upon presentation of an advertisement, movie, or other television program, an indication such as an icon may be presented to a viewer indicating that product or service information is available. A viewer may select the icon and store the corresponding product or service information in a virtual shopping cart or shopping list. The receiver may present the virtual shopping cart containing viewer selections on a virtual channel. A viewer may tune to the virtual channel and interact with the virtual shopping cart in order to add, delete, or initiate the purchase of products or services. Subsequently, purchase requests may be conveyed via Internet or otherwise. In addition, the receiver may be configured to communicate with other devices, such as a handheld computing device.

### BACKGROUND OF THE INVENTION

1. Field of the Invention

The invention relates generally to interactive television systems and more particularly to a system and method for shopping in an interactive television system.

2. Description of Related Art

Interactive television systems provide a means to deliver interactive content as well as ordinary television audio and video to a large number of subscribers. Programs broadcast by these systems may incorporate television audio and video, still images, text, interactive graphics and applications, and many other components. The interactive content of the interactive television signal may therefore include application code, data associated with the audio and video, control signals, raw data and many other types of information. Both the interactive content and the audio and video data may be delivered to subscribers as “pushed” data. That is, the data is delivered to each of the subscribers, regardless of whether or not the subscribers requested the data.

The interactive functionality of the television is generally controlled by a set-top box connected to the television. The set-top box receives the signal transmitted by a broadcast service provider, separates the interactive portion from the audio-video portion and decompresses the respective portions of the signal. The set-top box uses the interactive information to, for example, execute an application while the audio-video information is transmitted to the television. The set-top box may combine the audio-video information with interactive graphics or audio generated by the interactive application prior to transmitting the information to the television. The interactive graphics and audio may present additional information to the viewer or may prompt the viewer for input. The set-top box may provide viewer input or other information to the broadcast service provider via a return path.

Interactive content such as application code or information relating to television programs is usually broadcast in a repeating format. In other words, each piece of information is broadcast a first time, then each is transmitted a second time, and so on. The cycle is repeated so that each piece of interactive data is transmitted, for example, every ten seconds. The pieces of information which are broadcast in this manner form what can be referred to as a “carousel.” Frequently, a single carousel is transported as a contiguous data stream. However, it is also possible to multiplex two or more carousels in a single data stream.

Broadcast systems (e.g., interactive television systems) transmit information in a carousel format in order to allow receivers in the system to selectively obtain particular pieces of information in the carousel without requiring a return path from the receivers to the server. If a particular receiver needs a particular piece of information, it can simply wait until the next time that piece of information is broadcast, and then extract the information from the broadcast data stream. Other receivers in the system can operate in the same manner, each receiver waiting for the information it needs, and then using only that information. By employing carousels to broadcast information, the system eliminates the need to connect each of the receivers with the server and further eliminates the need for the server to process individual requests for information. Generally, a broadcast signal may include a number of programs which in turn may include a number of audio/video streams and/or data streams. Data streams may be used to carry data such as interactive application data, subtitle information, or other data.

The pieces of information, or data objects, in a carousel may be intended to be combined in a single object data stream to form a program. This program may also contain streaming data such as audio or video. For example, an interactive television game show may combine television audio and video with interactive content such as application code which allows users to answer questions. Another example would be a news program which combines audio and video with application code that inserts current stock prices in a banner at the bottom of the screen. (It should be noted that many types of programs are possible, and it is not necessary to include either audio, video or interactive content with any particular program. A program might contain only audio and interactive data (e.g., an interactive radio program,) or it might contain only interactive data (e.g., an interactive weather program that does not contain audio or video streams.) Typically, each program is associated with a corresponding channel and, when a channel containing a particular program is selected by the interactive television receiver, the data which is being broadcast on that channel is downloaded and the program is started.

One of the advantages of interactive television involves using interactive content to enhance the content of a particular broadcast program. For example, during the broadcast of a sporting event such as a baseball game additional content may be transmitted to the viewer in order to enhance their viewing experience. In one example, numerous statistics related to the ongoing baseball game may be included as interactive content. To indicate to the viewer such added content is available, an icon or menu may be displayed on the television with which the viewer may interact. If the viewer desires to view the additional content, the icon is selected or a menu item is selected which then display the additional content. In this manner, only those viewers who wish to view the additional content will see it displayed on their screen. Viewers who do not wish to view the additional content will not have their view of the program obstructed or altered in any way.

While the audio and video provided through a television system enables products and services to be offered to consumers, obstacles remain between the offering of a product or service to a viewer and that viewer actually making a purchase. First, in addition to being interested in the product or service, the viewer must remember their interest in the product or service. In some cases a viewer may make a written or mental note of their interest in the product or service. Subsequently, the viewer must go shopping for the product or service. A second obstacle is that the viewer may not know where to purchase the product or service or may only know of inconvenient locations for such a purchase. In some instances a viewer may seek to make the purchase online via the World Wide Web (Web), but here again the viewer may be forced to perform searches to find a location to purchase the product or service.

What is desired is a mechanism for facilitating a viewer's purchase of a product based on that viewer's interest in the product.

### SUMMARY OF THE INVENTION

The problems outlined above may be solved by various embodiments of the invention described herein.

In one embodiment, a method and mechanism for facilitating product purchases in an interactive television system are described. Generally speaking, a broadcast programming stream is conveyed from a broadcast station to a receiver. In addition to programming content, the stream which is broadcast has been tagged with information describing products and services which may be purchased. Upon presentation of an advertisement or other program, an indication such as an icon may be presented to a viewer that product or service information is available. In one embodiment, a viewer may indicate an interest in the product or service by pressing a button on a remote control and storing the corresponding product for later retrieval. The receiver may subsequently present the product information in the form of a virtual shopping cart or shopping list on a virtual channel. A viewer may tune to the virtual channel and interact with the virtual shopping cart or list in order to initiate the purchase of products. Subsequently, purchase requests may be conveyed via Internet or otherwise. In addition, other devices may be configured to communicate with the receiver and store additional information in the virtual shopping cart. Alternatively, the receiver may convey stored information to another device, such as a handheld computing device.

In one embodiment, a system for facilitating product purchases is described wherein a first source is configured to convey a broadcast stream including product information and a second source is configured to convey an executable interactive application. The application is configured to detect product information in a broadcast stream, present an indication of its presence, receive input from a viewer corresponding to the indication, store the product information, and subsequently retrieve the information for use in initiating a purchase request for the product.

Also contemplated is a device for facilitating purchases in an interactive television system. The device includes a signal receiver configured to receive a broadcast stream; and a mechanism coupled to the receiver which is configured to detect the presence of a product data within the broadcast stream, present an indication of the presence of the product data, receive input from a viewer corresponding to the indication, store the product data in response to the viewer input, retrieve and present the stored data, and finally initiate a purchase request for the product.

Also contemplated is a carrier medium comprising information describing program instructions, wherein the program instructions are executable to detect the presence of product data in a broadcast stream, present an indication of the presence of the product data in the broadcast stream, receive input corresponding to said indication, store the product data in response to receiving the input, retrieve the data, present the product data, and initiate a purchase request for the product.

### BRIEF DESCRIPTION OF THE DRAWINGS

Other objects and advantages of the invention will become apparent upon reading the following detailed description and upon reference to the accompanying drawings in which:

FIG. 1 is a diagram of one embodiment of an interactive television system.

FIG. 2 is a diagram of one embodiment of a headend.

FIG. 3 is a block diagram of one embodiment of a receiver.

FIG. 4 illustrates an overview of one method for facilitating purchases.

FIG. 5 is a diagram of one embodiment of a headend.

FIG. 6A illustrates an interactive display.

FIG. 6B illustrates an interactive display.

FIG. 6C illustrates an interactive display.

FIG. 7 illustrates one embodiment of menu selections.

FIG. 8 illustrates one embodiment of a virtual shopping cart.

FIG. 9 illustrates one embodiment of communication between a receiver and alternative devices.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Overview

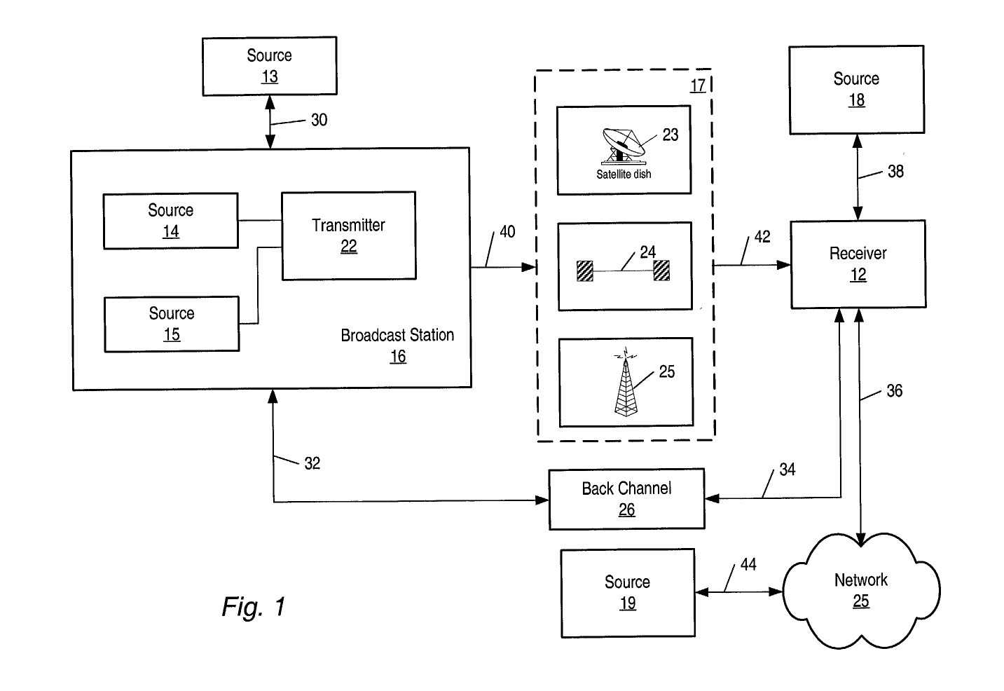

Referring to FIG. 1, one embodiment of an interactive television system is shown. In the embodiment shown, a receiving device 12 is coupled to several sources of interactive television content. Receiving device 12 may include any number of suitable devices, examples of such devices include a set-top box (STB), a television (TV), a video cassette recorder (VCR), a personal video recorder (PVR), a personal digital assistant (PDA), a personal computer (PC), a video game console, or a mobile/cell phone. While the content may be delivered through many different delivery mechanisms, three exemplary mechanisms are shown in the figure.

Included in the embodiment of FIG. 1, a broadcast station 16 is coupled to a receiver 12 via a transmission medium 17 and back channel 26. In addition, receiver 12 is coupled to a source 18 and network 25. Further, broadcast station 16 is coupled to a source 13, and network 25 is coupled to a source 19. In the embodiment shown, broadcast station 16 includes sources 14 and 15 and transmitter 22. Transmission medium 17 may comprise a satellite based system 23, a cable based system 24, a terrestrial or multiple multi-point distribution service (MMDS) based system 25, a combination of these systems, or some other appropriate system of transmission.

In the embodiment of FIG. 1, broadcast station 16 may include a variety of sources 14, 15 and 16 of content to be utilized and conveyed by transmitter 22. Content sources 14, 15, and 16 may include databases, application servers, other audio/video sources, or other data sources. In one embodiment, content may be created at a source 14 which may include an authoring station configured to create such content. An authoring station may include a computer workstation configured with software which aids in the development of interactive content. An authoring station may be part of broadcast station 16 in which case the conveyance of the created content may be through a local computing network, or similar configuration. Alternatively, an authoring station may be remotely located 13 from broadcast station 16. In an embodiment where authoring station is not directly coupled to broadcast station 16, the content created by a source 13 may be conveyed to broadcast station 16 via Internet, broadcast, cable, etc. In some cases, content created by at a remote location 13 may first be transferred to a storage medium, such as a CD-ROM or DVD-ROM, and transported to broadcast station 16 via more conventional means where it may be stored in a database or other storage device.

Subsequent to its creation, content from sources 13, 14 and 15 may be delivered to receiver 12 through a broadcast transmission network. This network consists essentially of a broadcast station 16 which assembles the content from sources 13, 14 and 15 and processes (e.g., digitizes, compresses and packetizes) the content, and a transmission network 17 which receives the content from broadcast station 16 and conveys it to receiving device 12. (It should be noted that receiving device 12 may be only one of many devices to which this content is distributed.) In one embodiment, broadcast station 16 includes software and/or hardware which is configured to process the content conveyed by sources 13, 14 and 15 as described above. A second delivery mechanism may include a direct point-to-point connection between receiver 12 and source of 18, which may be some type of server. This connection may be made via an ordinary telephone line. A third delivery mechanism may also be a point-to-point connection, but transmission of the content from a source 19 to receiver 12 is made via one or more shared networks (e.g., over the Internet). In one embodiment, source 19 may include an Internet based retailer (E-tailer) which is configured to provide product purchase services to those accessing its Web site. Also illustrated in FIG. 1 is a back channel (or return path) 26 by which receiver 12 may convey data to broadcast station 16. Back channel 26 may comprise a telephone line, cable, wireless, or other connection. As used herein, “product” includes tangible items, services, intangible items such as a franchise license, or any other purchasable commodity.

One delivery mechanism, the direct point-to-point connection to a source of content, may comprise communication via an ordinary telephone line. This type of connection is typically initiated by the receiver to convey information to, or retrieve information from, a data server. Another delivery mechanism, the point-to-point connection through one or more networks, may comprise a typical connection between nodes on the Internet. Because data may be routed through many different shared networks in this case, it may be read, stored and written many times as it is transmitted from source 19 to receiver 12. The third delivery mechanism may include a satellite, cable or terrestrial broadcast network.

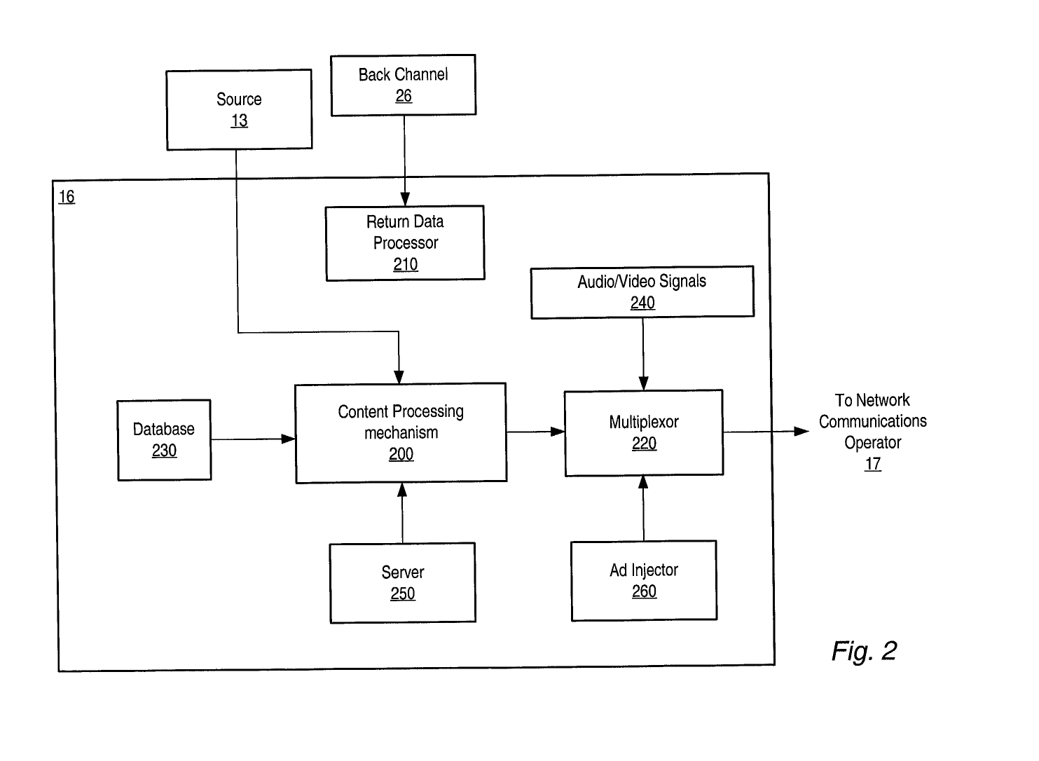

Turning now to FIG. 2, an overview of one embodiment of a broadcast station (head-end) 16 is shown. The broadcast station 16 of FIG. 2, includes an application server 250 and a database 230 which contains previously created interactive content. Also shown in FIG. 2 is a source 13 of content which is external to broadcast station 16 and coupled to broadcast station 16. Database 230, server 250, and source 13 are coupled to a content processing mechanism 200 which is configured to process the content received and convey the processed content to a multiplexor 220. Also coupled to multiplexor 220 is a source 240 of audio/video signals and an ad injector 260. Ad injector 260 may be configured to insert advertisements into a broadcast stream. Both content processing mechanism 200 and ad injector 260 may be configured to convey advertisements to multiplexor 220. Further, advertisements conveyed by content processing mechanism 200 and/or ad injector 260 may include interactive content or other data corresponding to the advertisement being conveyed.

In one embodiment, content processing mechanism 200 may comprise a computer and may also be coupled to receive and convey content from the Internet or World Wide Web. Processing mechanism 200 is configured to convey the processed content to multiplexor 220. Multiplexor 220 is also coupled to receive audio/video signals 240 and advertisements 260. Multiplexor 220 multiplexes the received signals and conveys the multiplexed signal to network communications operator 17 where it is subsequently conveyed to a receiving device. Finally, broadcast station 16 includes a return data processor 210 coupled to back channel 26. In one embodiment, return data processor 210 may comprise a modem which receives data for further processing within broadcast station 16. While the above description describes a source of interactive content as being at a broadcast station 16, in an alternative embodiment database 230 and content processing mechanism 200 may reside at the location of a network communications operator 17. An example of such an alternative embodiment may be a cable station which inserts interactive content into a broadcast signal prior to transmission.

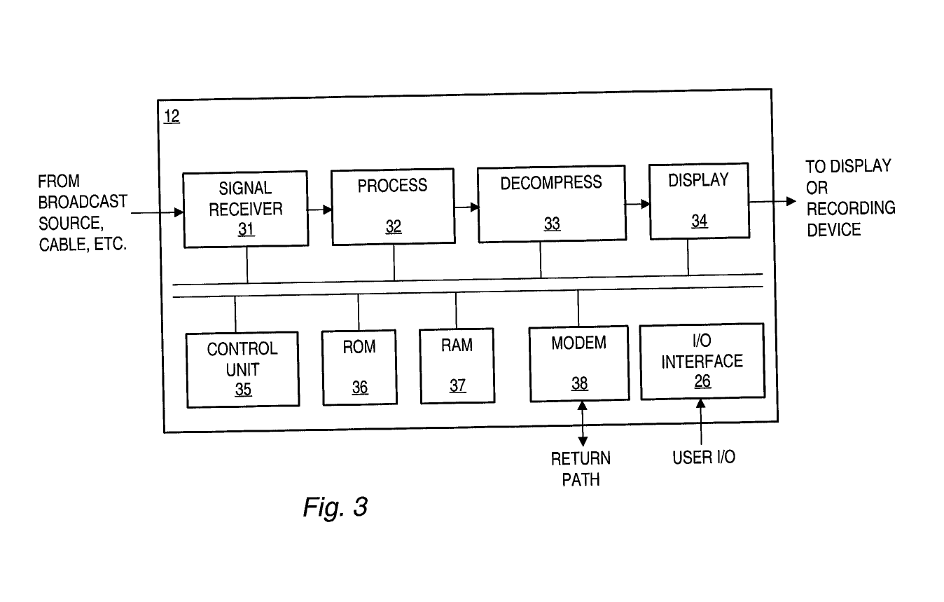

Referring to FIG. 3, a block diagram of a receiver 22 is shown. In one embodiment, receiver 22 is implemented in a set-top box for a television. In other embodiments, the receiver may be incorporated into the circuitry of other components of a receiving station, such as a television, a video game console, a mobile/cell phone, or other device. Interactive television content is delivered to receiver 22 through a signal receiver such as tuner 31. In this embodiment, a broadcast signal is fed into tuner 31 which selects a channel on which broadcast interactive content is transmitted and passes the content to processing unit 32. (It should be noted that interactive television content may also be delivered to receiver 22 through other signal receivers, such as modem 38.) The interactive television signal may contain information in addition to the television programming. For example, interactive application modules, control signals or other data may be embedded in the broadcast signal. Alternative embodiments of receiver 22 may include, or be coupled to, a mass storage device such as a hard disk drive.

In the case of a digital satellite transmission, the content may be formatted into packets, so processing unit 32 demultiplexes packets from the broadcast signal, and reconstructs the packets into what is typically a compressed television program and/or interactive application embodied in the received content. The decompression is performed by decompression unit 33. The audio and video information associated with the television program embodied in the signal is then conveyed to display unit 34, which may perform further processing and conversion of the information into a suitable television format, such as NTSC or HDTV audio/video. Applications reconstructed from the broadcast signal may be routed to random access memory (RAM) 37 and are executed by control unit 35. The user can interact with the applications or other interactive content through I/O devices coupled to I/O interface 26. I/O interface 26 is configured to receive input from a viewer. For example, a viewer may utilize an infrared remote control which is detected by interactive receiving unit 26. Alternatively, a viewer may utilize input devices such as a mouse, writing tablet, voice, or other device which is detected by interactive receiving unit 26. Many other possible viewer input devices are possible and are contemplated. (It should be noted that the foregoing description of the functionality of the interactive television system is only an example of such a system, and is not intended to be limiting.)

Control unit 35 may comprise a microprocessor, micro-controller, digital signal processor (DSP), or some other type of instruction processing device. Memory 36 may include memory units which are static (e.g., SRAM), dynamic (e.g., DRAM), volatile or non-volatile (e.g., FLASH), as required to support the functions of the receiver. System code is typically stored in FLASH memory. When power is applied to the receiver, control unit 35 executes operating system code which is stored in memory 36. The operating system code executes continuously while the receiver is powered in the same manner the operating system code of a typical personal computer (PC) and enables the receiver to execute control information and application code.

In one embodiment, a viewer uses a remote control to provide input to receiver 22. I/O interface 26 detects input provided by a viewer. Input received from a viewer via I/O interface 26 may then be stored in a message queue for processing by control unit 35. For example, receiver 22 may execute an interactive application which is configured to process commands and other input by a viewer by accessing a particular address region in RAM 37. In such a configuration, a message queue for storing viewer input may be located at that particular address region. Alternatively, an interactive application may be configured to detect and receive input via the operating system code. Numerous alternative configuration for conveying viewer input to an interactive application are possible and are contemplated.

The receiver is typically housed in a set-top box connected to a user's television. It should be noted that the receiver may comprise any processing unit for receiving and processing the interactive television content. The receiver may be in a set-top box housing which physically sits on top of a television, it may be in some other location external to the television (e.g., on the side or back of the television or remotely located from the television), or it may be incorporated into the television itself. Similarly, the television to which the output of the receiver is directed may comprise a television or a video monitor employing any suitable television format (e.g., NTSC or HDTV), or it may be replaced by other devices, such as a recording device.

Purchase of Products or Services

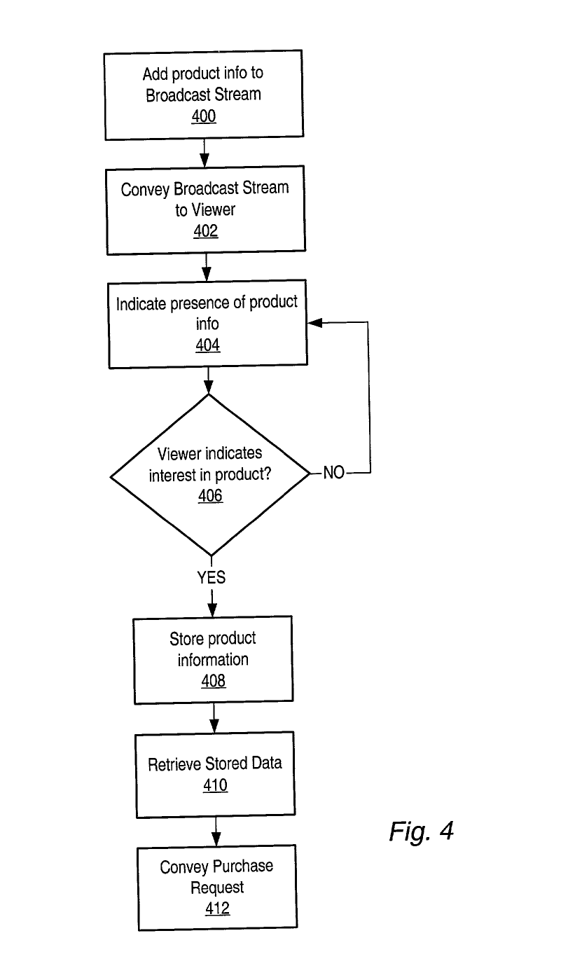

Typically, a television broadcast includes advertisements for products and services. These advertisements generally include audio and video designed to capture the attention and interest of viewers and convey information about the product or service being advertised. While it is most common to associate products and services with advertisements, products and services may be associated with any type of television broadcast. FIG. 4 illustrates an overview of one embodiment of a method for facilitating a viewer's purchase of a product or service utilizing information in a television broadcast stream. Initially, information related to a product or service is added to a broadcast stream (block 400) which is subsequently conveyed to a viewer (block 402). In addition to displaying the ordinary audio/video corresponding to the broadcast, an indication is displayed (block 404) to the viewer that product information is currently available. For example, an icon may appear on the screen indicating product information is available. If the viewer is interested in the product or service, they may select the icon with a remote control or other device which provides them the opportunity to record their interest in the product (block 408). However, rather than interrupting the viewer's viewing enjoyment with several menus and selection options, the product information may be simply stored for later retrieval at a time which is more convenient. For example, in one embodiment, upon the appearance of an icon or other indication that a service or product is available, a viewer may press a single button on their remote control to store the product information for later retrieval. Later, perhaps after the viewer completes watching the current television program, the viewer may retrieve the stored product information for review (block 410). At that time, if the viewer decides to purchase that product, purchase information relating to the product may be conveyed to an Internet based E-tailer for purchase (block 412). Advantageously, a viewer is able to store information about a product or service they are interested in for later access. The viewer need not remember or make notes about the product or service, their viewing enjoyment is not interrupted, and they may easily initiate a purchase without even leaving their home. Further, advertisers and retailers benefit by making it easier and more convenient for viewers to purchase their products and services.

Tagging Broadcasts

Before a viewer may access product information being conveyed with a broadcast, product information must be included in the broadcast stream (i.e., the broadcast is “tagged” with product information). Typically, product or service information will be inserted into a broadcast stream to coincide with an advertisement for that product or service. However, as mentioned above, product information may accompany any type of broadcast. For example, information related to a book which is being discussed on television may be added to the broadcast. Similarly, information related to music which is being played may be added to the broadcast. Further, information related to a product or service appearing in the scene of a movie or television show may be added to the broadcast. For example, information related to a designer outfit worn by an actress in a movie may be added to the broadcast. Numerous variations are possible.

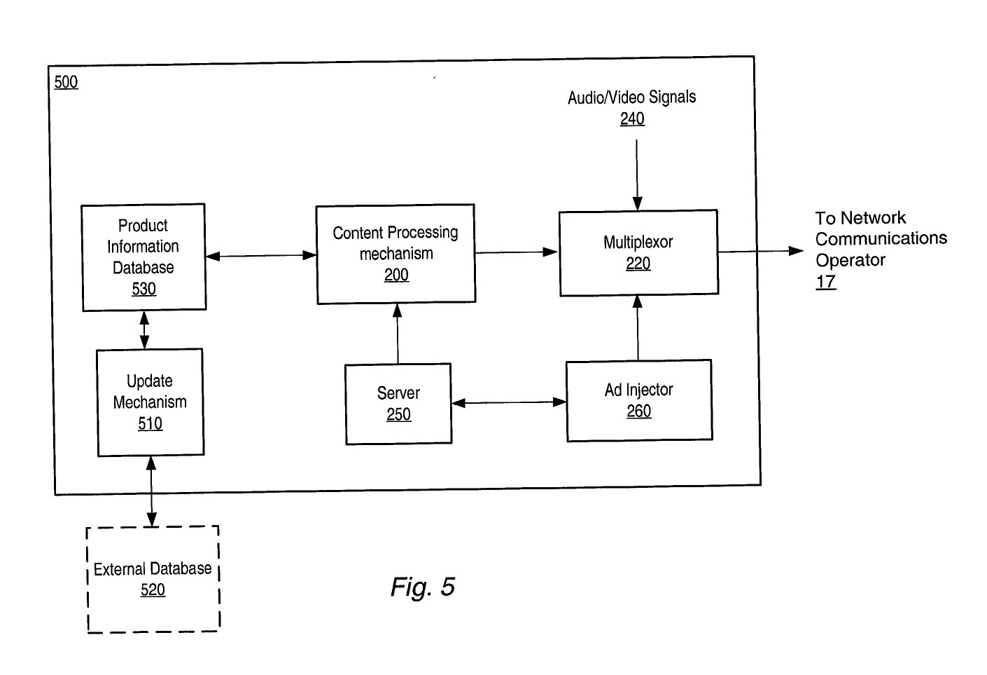

Tagging of broadcasts with product information may occur virtually anywhere in the broadcast chain. Typically, product information may be inserted into the broadcast at the headend. However, advertisements and other broadcast content may be created with corresponding product information. FIG. 5 illustrates one embodiment of a portion of a headend 500 where product information may be inserted into the broadcast stream. Headend 500 includes an update mechanism 510 and a product information database 530 which includes information related to products and services. Update mechanism 510 is configured to update the data contained in database 530. In one embodiment, a broadcast station operator may configure update mechanism 510 to update database 530 on a periodic basis with data provided to the station 500 via conventional means. For example, update mechanism 510 may represent a computer which downloads data to database 530 from a local storage device. However, in an alternative embodiment, update mechanism 510 may be configured to dynamically update database 530 with “live” product and service data obtained via Internet, or some other channel. For example, update mechanism 510 may be configured to access product information storage locations via Internet which are provided by manufacturers, retailers, advertisers, or others. Alternatively, a third party product information supplier may configure an external database 520 with product and service information corresponding to a variety of manufacturers, retailers, advertisers, etc. Advantageously, a centralized product information database 520 may be maintained which a broadcast station operator may access.

As illustrated in the embodiment of FIG. 5, content processing mechanism 200 may receive product information from database 530. Server 250 may be configured to communicate with ad injector 260 to coordinate adding product information with a corresponding advertisement. Multiplexor 220 then multiplexes signals 240 with the content provided by processing mechanism 200 and injector 260, and conveys the resulting signal. As previously mentioned, product information may be added to a broadcast stream at many places within the broadcast chain. Consequently, broadcast station 500 may receive audio/video signals 240 which already include product information. Alternatively, broadcast station 500 may be configured to convey a broadcast stream which includes an indication that particular product information is to be retrieved at a particular time. Subsequently, for example at a receiver such as a set-top box, an application executing within the receiver may detect the indication and access an Internet site for corresponding product information.

Product and Service Information

Product and service information which is added to a broadcast stream may include any type of information which is appropriate. For example, an advertisement for a coffee maker may include basic product information on the manufacturer, list price, the capacity of the coffee maker, a programmable timer, power requirements, dimensions, and warranty. However, information such as reviews of the coffee maker, retailers, and e-tailers, where the product may be purchased may also be included. Retailer information may also include competitive pricing information and availability. Further, product information may be tailored to a particular viewing audience based on geography, time of day, viewer preference profiles, and so on. For example, a broadcast stream may only include retailers within the region of broadcast, rather than retailers nationwide. Alternatively, a receiver may be configured to extract particular product information from a broadcast stream based on a profile stored within the receiver. For example, a set-top box may be configured to extract retailer information corresponding to only those retailers in the same zip code as the viewer. Countless variations and combinations of the above are possible and are contemplated.

Viewer Selections and Virtual Shopping Carts

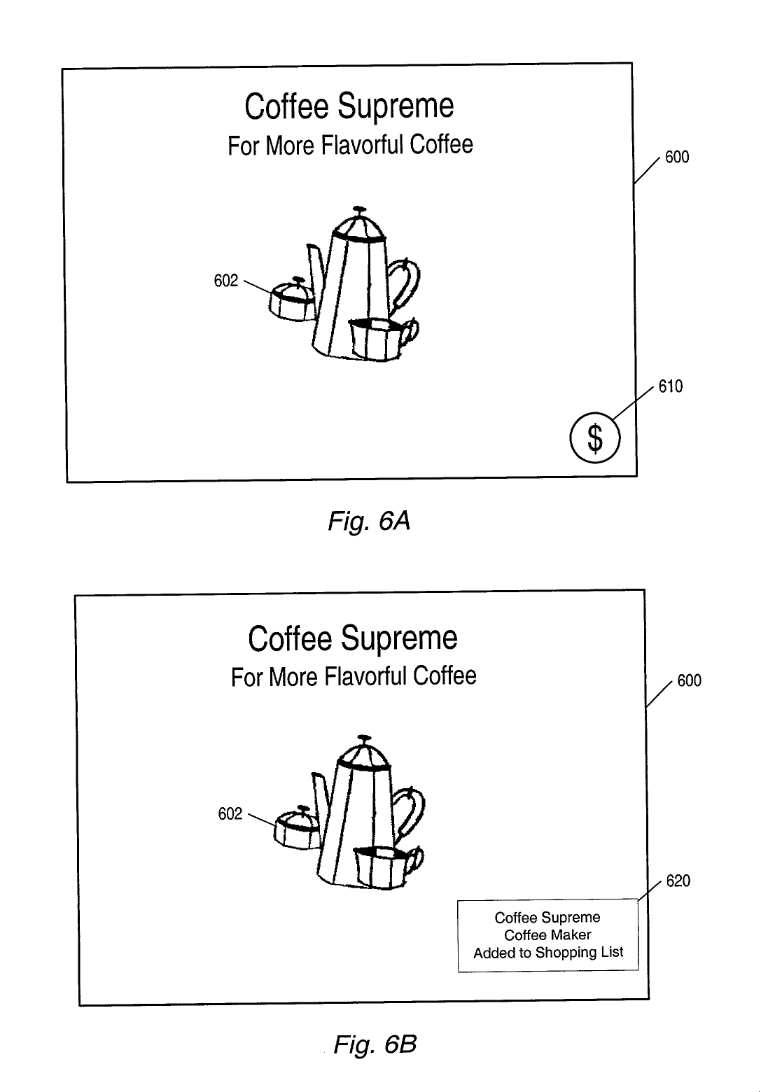

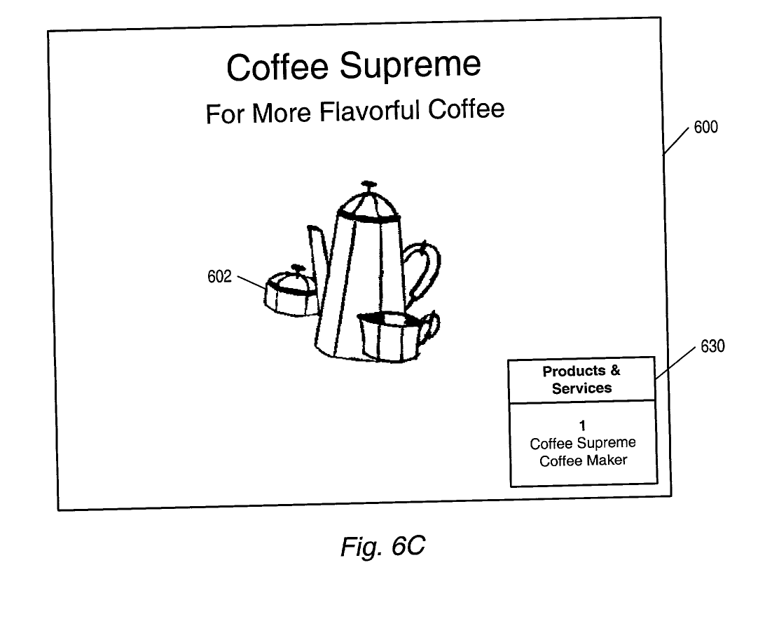

Turning now to FIG. 6a, one embodiment of a display 600 in which corresponding added content is available is shown. Display 600 may be any display device capable of presenting images to a viewer, preferably a television display. In FIG. 6a, an advertisement for a product 602 is displayed. In addition, an icon 610 is displayed on the screen indicating further product information is available. In one embodiment, application software executing within a set-top box detects the product information which has been added to the broadcast stream and displays the icon 610.

FIG. 6b illustrates the display of FIG. 6a subsequent to a viewer indicating an interest in the product or service being offered. In one embodiment, in response to the display of icon 610, a viewer may press a single button on a remote control or other device to indicate an interest in the product or service being offered. Subsequent to indicating such an interest, a message 620 may be displayed informing the viewer that the product or service has been added to their shopping list. In one embodiment, the message 620 may be displayed for only a short time so as not to unduly interfere with the viewer's viewing experience. Advantageously, a viewer may quickly add an item to a shopping list for later retrieval without interrupting their viewing enjoyment.

FIG. 6c illustrates an alternative embodiment. After display of an icon 610 and a viewer indicating an interest in the product or service, icon 610 may be replaced by a menu 630 providing further options. Menu 630 may provide further detail about product or service information included in the broadcast stream. In the example of FIG. 6b, menu 620 may include a list of one or more items begin offered and may include any number of options related to those items. In the simple example shown, information concerning only a single item, the “Coffee Supreme Coffee Maker”, is available.

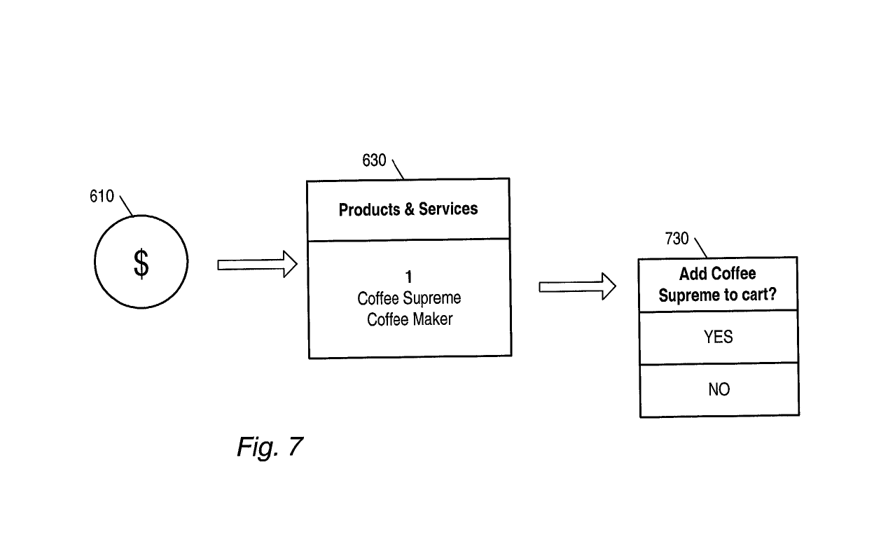

FIG. 7 shows one possible embodiment of menus which may be utilized by a viewer to record interest in a particular product. In one embodiment, traversal of menus and menu items may include utilizing arrow keys on a remote control to highlight different menu items and pressing a button to select a particular menu item. However, any suitable means of maneuvering and selecting items displayed on a display device may be utilized. FIG. 7 shows the transformation of each icon or menu item upon selection by a viewer. For example, selecting icon 610 in FIG. 7, results in menu 630. Selecting item “1” of menu 630 results in menu 730. Menu 730 gives a viewer the option of recording their interest in the corresponding product for later reference by adding the corresponding product's information to a virtual shopping cart. Rather than using a shopping cart metaphor, other embodiments may utilize a shopping list, or any other suitable metaphor. In one embodiment, the product information is stored within a storage device of a set-top box. However, the location where the information is stored may be at any location which is accessible by the viewer.

While the exemplary embodiment of FIG. 7 allows a viewer to simply record information corresponding the a product for later reference, many other options may initially be provided for the viewer's selection. For example, a viewer may be given the option to directly purchase the product or select a particular retailer for purchase of the product. Further, the viewer may be given the option of accessing a Web site related to the product for further information wherein a Web browser is executed on a set-top box or the Web site is presented in a window within the current broadcast channel being viewed. Numerous variations are possible. In an embodiment where a viewer may select among a number of options when initially indicating an interest in products or services, menus, options, and other items may be displayed in a semi-transparent manner so as to minimize obstruction of the program being displayed.

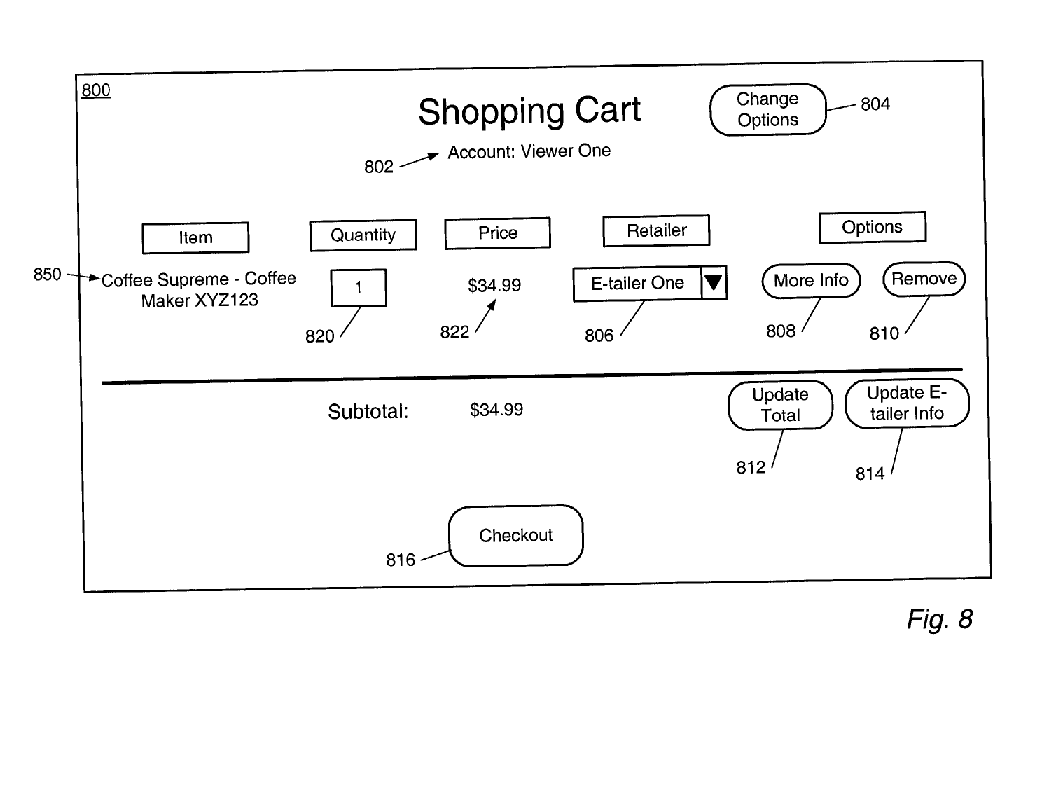

Whether the viewer wishes to view the stored product information immediately or at a later time, one embodiment for presentation of the information is in the form of a “virtual shopping cart”. FIG. 8 illustrates one embodiment of a virtual shopping cart. In the embodiment shown, a virtual channel may be created by a receiver for display of the shopping cart. In the example of FIG. 8, a virtual channel 800 is displayed on a television. In the embodiment shown, the display and stored information may be maintained by an interactive application and/or operating system software executing within a set-top box coupled to the television. Alternatively, maintenance of the display may occur external to the set-top box (e.g., at a remote location accessed via Internet). Conveniently, a viewer may tune to this virtual channel to access information previously stored.

The virtual shopping cart shown in FIG. 8 includes a list of items 850 in which a viewer has previously indicated an interest. Each item 850 listed includes a selectable quantity 820, a price 822, a selectable retailer for purchase of the item 806, an option for obtaining more information related to the product 808, and an option for removing the item from the list. In the exemplary embodiment shown, the name of the viewer 802 which these selection correspond to is also shown. Option button 804 is also provided for changing other options related to the current shopping cart. For example, different viewers may have their own password protected shopping carts. By selecting option button 804, a viewer may be able to change the current shopping cart to a different viewer's shopping cart.

In FIG. 8, a viewer may select from a number of different retailers via a drop down list 806. Alternately, a viewer may configure a default retailer or selection of retailer. An option button 814 is provided for updating pricing information when a different retailer is selected. For example, a viewer may select an alternate which is known to have better product availability. The viewer may then update the product information via Internet by selecting option button 814. Alternatively, selecting a different retailer 806 may automatically attempt to update pricing information. Update total button 812 may be selected to provide an updated subtotal based on the currently selected quantity and price. Finally, if a viewer simply wishes to obtain further information regarding the product, more info button 808 may be selected. Once the viewer is ready to make a purchase, they may select the checkout option 816 where a purchase may be completed.

While the above embodiment displays items in a virtual shopping cart, an initial presentation may be made to a viewer with only a list of the items where the viewer is given an option to add them to a shopping cart, remove them, review them, or otherwise.

Connected Devices

To further take advantage of the capabilities of the above described embodiments, other devices may be used in conjunction with the above receiver. For example, a viewer may have other devices in their household which are used to record information. A viewer may have a device coupled to an appliance such as their refrigerator for recording needed grocery items. Additionally, a viewer may be accustomed to using a handheld device, such as a personal digital assistant (PDA), for keeping track of items to remember or purchase. In one embodiment, data which is stored by these other devices may be conveyed to a receiver where they may be added to a virtual shopping cart, or otherwise reviewed as described above. Further, a receiver may be configured to convey data to these other devices as well. For example, while watching television a viewer may store product or service information which is offered via a broadcast. Subsequently, that information may be conveyed from the receiver to a PDA which the viewer may then use as a shopping list while shopping.

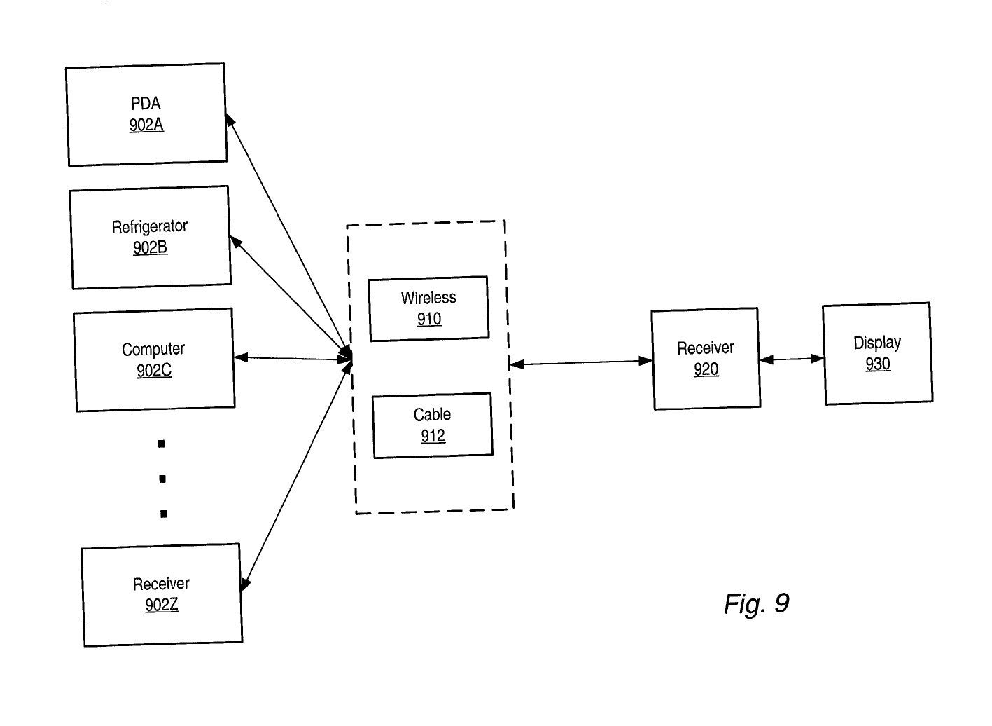

FIG. 9 illustrates one embodiment wherein are devices may communicate with the receiver described above. Included in FIG. 9 are a PDA 902A, appliance coupled device 902B, computer 902C, and other devices 902Z capable of communicating information. Elements referred to herein with a particular reference number followed by a letter will be collectively referred to by the reference number alone. For example, devices 902A-902Z will be collectively referred to as devices 902. Also included are a receiver 920 coupled to a display device 930. In one embodiment, receiver 920 is a set-top box as described above and display 930 is a television. In the embodiment shown, devices 902 may communicate with receiver 920 via wireless 910 or cable 912 medium. One example of communication between a device 902 and receiver 920 may be a clothes washer configured with a reservoir to store laundry detergent. When the clothes washer detects the laundry detergent is running low, a wireless indication to purchase more may be conveyed to receiver 920. Alternately, a person may have stored a list of items for purchase on a PDA which may subsequently be conveyed to receiver 920. Numerous scenarios such as those above exist. In general, any device which is capable of communicating with receiver 920 may be utilized. Subsequent to conveying information from devices 902 to receiver 920, a viewer may tune to a virtual channel as described above for reviewing the conveyed information. The viewer may then select items for purchase via Internet, print out a list of items, or download a list of items or other data from a receiver to a PDA or other device for use while out shopping.

Various embodiments may further include receiving, sending or storing instructions and/or data implemented in accordance with the foregoing description upon a carrier medium. Generally speaking, a carrier medium may include transmission media or signals used in broadcast systems and otherwise such as electrical, electromagnetic, or digital signals, conveyed via a communication medium such as network and/or a wireless link. For example, a network operator may convey signals which describe program instructions via a broadcast system. A carrier medium may also include storage media or memory media such as magnetic or optical media, e.g., disk or CD-ROM, volatile or nonvolatile media such as RAM (e.g. SDRAM, RDRAM, SRAM, etc.), ROM, etc.

While the present invention has been described with reference to particular embodiments, it will be understood that the embodiments are illustrative and that the invention scope is not limited to these embodiments. For example, while discussed in terms of television systems, the invention may also be used in the context of a device coupled to the Internet, such as a personal computer or video game platform. In such an embodiment, a user may have a broadband connection to the Web, such as via cable modem or DSL whereby programs, interactive applications and scripts are received. Many variations, modifications, additions and improvements to the embodiments described are possible. These variations, modifications, additions and improvements may fall within the scope of the invention as detailed within the following claims.

What is claimed is:

1. A system for facilitating product purchases in an interactive television system comprising:
a first source configured to convey a broadcast stream; and
a second source configured to convey an interactive application, wherein said interactive application is executable to:
receive a first data corresponding to a first product;
present said first product; and
initiate a purchase request corresponding to said first product.

2. The system of claim 1, wherein said first source and said second source are located within a broadcast station.

3. The system of claim 2, wherein said broadcast stream includes said first data, and wherein said first data is received by said interactive application via said broadcast stream.

4. The system of claim 2, wherein said interactive application is configured to receive said first data from a handheld computing device.

5. The system of claim 3, wherein said interactive application is further executable to:
detect the presence of said first data within said broadcast stream;
present an indication of said presence of said first data in said broadcast stream;
receive input corresponding to said indication, wherein said input is initiated by a viewer; and
store a second data corresponding to said first data in response to said input from said viewer.

6. The system of claim 5, further comprising a receiver configured to receive said broadcast stream and said interactive application, wherein said receiver is configured to execute said interactive application.

7. The system of claim 3, further comprising a mechanism configured to add said first data to said broadcast stream by tagging said broadcast stream with said first data.

8. The system of claim 6, wherein said indication is presented on a display coupled to said receiver, and wherein said indication is presented concurrently with a second presentation corresponding to said first product on said display.

9. The system of claim 6, wherein said second data is stored on a storage device coupled to said receiver.

10. The system of claim 9, wherein said receiver is a set-top box.

11. The system of claim 8, wherein presenting said first product comprises presenting said first product as an item for purchase in a virtual shopping cart, wherein said virtual shopping cart is presented on said display.

12. The system of claim 11, further comprising interacting with said virtual shopping cart, wherein said interacting is by a viewer, and wherein initiating said purchase request for said first product is in response to said interacting by said viewer.

13. The system of claim 12, wherein said purchase request is conveyed to an on-line retailer.

14. The system of claim 5, wherein said interactive application is further executable to convey a third data corresponding to said second data to a first device.

15. The system of claim 14, wherein said first device is a handheld computing device.

16. A method for facilitating product purchases in an interactive television system comprising:
receiving a broadcast stream with a first data corresponding to a first product;
detecting said first data within said broadcast stream;
presenting an indication of the presence of said first data in said broadcast stream;
receiving input corresponding to said indication, wherein said input is initiated by a viewer; and
initiating a purchase request for said first product.

17. The method of claim 16, further comprising:
storing a second data corresponding to said first data in response to said input from said viewer;
retrieving said second data; and
utilizing said second data to present said first product as an item for purchase in a virtual shopping cart.

18. The method of claim 17, wherein said broadcast stream is received by a receiver, wherein said second data is stored on a storage device coupled to said receiver, and wherein said indication and said first product are presented on a display coupled to said receiver.

19. The method of claim 17, further comprising interacting with said virtual shopping cart, wherein said interacting is by a viewer, and wherein said purchase request for said first product is initiated in response to said interacting by said viewer.

20. The method of claim 18, further comprising:
receiving a third data conveyed from a first device, wherein said third data is not received via said broadcast stream; and
storing said third data on said receiver.

21. The method of claim 18, wherein said indication is presented concurrently with a second presentation on said display corresponding to said first product.

22. The method of claim 21, wherein said receiver is a set-top box.

23. The method of claim 20, wherein said first device is a handheld computing device.

24. The method of claim 18, further comprising conveying a third data corresponding to said second data to a handheld computing device.

25. A device for facilitating purchases in an interactive television system comprising:
a signal receiver, wherein said receiver is configured to receive a broadcast stream; and
a mechanism coupled to said receiver, wherein said mechanism is configured to:
detect the presence of a first data corresponding to a product within said broadcast stream;
present an indication of said presence of said first data in said broadcast stream;
receive input corresponding to said indication, wherein said input is initiated by a viewer;
store a second data corresponding to said first data, in response to said input;
retrieve said second data; and
utilize said second data to initiate a purchase request for said product.

26. The device of claim 25, wherein said mechanism comprises a processor configured to execute program instructions.

27. The device of claim 26, wherein said receiver is configured to receive an interactive application, and wherein said mechanism is configured to subsequently execute said interactive application.

28. The device of claim 25, wherein said indication is presented on a display coupled to said mechanism.

29. The device of claim 28, wherein said indication is presented on said display concurrently with a second presentation on said display corresponding to said product.

30. The device of claim 28, further comprising a storage device coupled to said mechanism, wherein said mechanism is configured to store said second data on said storage device.

31. The device of claim 30, wherein said device is a set-top box.

32. The device of claim 28, wherein subsequent to retrieving said second data, said mechanism is configured to present said product as an item for purchase in a virtual shopping cart, wherein said virtual shopping cart is presented on said display.

33. The device of claim 32, wherein said mechanism is further configured to enable a viewer to interact with said virtual shopping cart, and wherein said purchase request for said product is initiated in response to said interacting by said viewer.

34. The device of claim 26, wherein said mechanism is further configured to:
receive a third data conveyed from a first device, wherein said third data is not conveyed via said broadcast stream; and
store said third data on said storage device.

35. The device of claim 34, wherein said first device is a handheld computing device.

36. The device of claim 26, wherein said mechanism is further configured to convey a third data corresponding to said second data to a handheld computing device.

37. A carrier medium comprising program instructions, wherein the program instructions are executable to:
detect the presence of a first data in a broadcast stream, wherein said first data corresponds to a product;
present an indication of said presence of said first data in said broadcast stream;
receive input corresponding to said indication;
store a second data corresponding to said first data in response to said input; and
initiate a purchase request for said product.

38. The carrier medium of claim 36, wherein said program instructions are further executable to:
retrieve said second data; and
utilize said second data to present said product as an item for purchase in a virtual shopping cart, wherein said virtual shopping cart is presented on a display.

39. The carrier medium of claim 37, wherein said instructions are further executable to enable interaction with said virtual shopping cart by a viewer, and wherein said purchase request for said product is initiated in response to said interacting by said viewer.

40. The carrier medium of claim 37, wherein said program instructions are further executable to:
receive a third data conveyed from a first device, wherein said third data is not received via said broadcast stream;
store said third data; and
utilize said third data to present an item corresponding to said third data as an item for purchase in said virtual shopping cart.

41. The carrier medium of claim 39, wherein said first device is a handheld computing device.

42. The carrier medium of claim 37, wherein said program instructions are further executable to convey a third data corresponding to said second data to a handheld computing device.
